(19) United States
(12) Patent Application Publication
(10) Pub. No.: US 2022/0289604 A1
(43) Pub. Date: Sep. 15, 2022

(54) METHOD FOR REDUCING HIGH LEVEL NUTRIENT CONTAMINANTS FROM PROCESS WASTEWATER

(71) Applicant: IER Environmental Services, Inc., Loon Lake, WA (US)

(72) Inventors: Richard Handley, Loon Lake, WA (US); JOSEPH HANDLEY, LOON LAKE, WA (US); MICHAEL ARD, COLLEGE PLACE, WA (US)

(73) Assignee: IER Environmental Services, Inc., Loon Lake, WA (US)

(21) Appl. No.: 17/690,987

(22) Filed: Mar. 9, 2022

Related U.S. Application Data
(60) Provisional application No. 63/158,810, filed on Mar. 9, 2021.

(51) Int. Cl. C02F 3/20; C02F 1/24; C02F 3/26; B01F 23/231

(52) U.S. Cl. CPC C02F 3/205; C02F 1/24; C02F 3/26; B01F 23/231265; B01F 23/231151; B01F 2101/305

(57) ABSTRACT

Provided is a wastewater treatment system. The wastewater treatment system includes an equalization (EQ) tank which receives contaminated wastewater having a high nutrient content from a plant, a dissolved air flotation (DAF) system and an on-site oxygen generation system which provides gas phase oxygen to the wastewater treated in the equalization (EQ) tank and/or the dissolved air flotation (DAF) system. The dissolved air flotation system includes at least one air dissolved air flotation vessel which may house an aerator grid assembly having a perforated lateral diffuser and optionally, a primary aerator assembly.

### CROSS REFERENCE TO RELATED APPLICATIONS

This application is related to and claims priority to and the priority benefit of U.S. Provisional Application No. 63/158,810 filed Mar. 9, 2021. The disclosure of the above-referenced application is hereby incorporated by reference in its entirety as if fully set forth herein.

### COPYRIGHT NOTICE

This disclosure is protected under United States and/or International Copyright Laws. ©2022 IER Environmental Services, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### TECHNICAL FIELD

Provided is a wastewater nutrient removal treatment system and a method for removing nutrients from wastewater.

### BACKGROUND

The present disclosure is directed to a wastewater contaminant and nutrient removal treatment system and a method for removing contaminants and nutrients from wastewater. The wastewater treatment system and corresponding method offers a safe and cost-effective solution for reducing nutrient values in wastewater using an on-site generated high purity oxygen supply that does not require storage of high quantities of dangerous bulk oxygen on site.

The wastewater treatment system disclosed herein is intended to offer a process to reduce the costs and regulatory pressures related to processing wastewater discharge. Any facility that faces high surcharges or regulatory pressures based on wastewater discharge contaminant levels can benefit greatly with rapid return on investment. Previous approaches include a Linde case study using bulk oxygen storage, anaerobic digestion and reverse osmosis installation.¹ The main disadvantages of these prior approaches include capital cost requirements and high operational costs as well as a requirement for storage of high volumes of dangerous and/or hazardous chemicals which were stored on site.

A major difference in the Linde approach compared to the approach disclosed herein (referred to as the Gener-Ox approach) is that the SOLVOX system mentioned in the Linde case study utilizes on-site storage of large quantity bulk oxygen whereas the Gener-Ox approach utilizes on-site generated oxygen by pressure or vacuum swing adsorption (PSA or VSA). The Gener-Ox on-site generated oxygen is “generated and used on the fly” as required rather than stored in bulk quantity. This eliminates a major aesthetic complaint and safety hazard since oxygen gas or liquid storage is extremely flammable.

### BRIEF DESCRIPTION OF THE DRAWINGS

FIG. 1 is a flow chart illustrating an exemplary wastewater nutrient removal treatment system. ¹ See https://www.refrigeratedfrozenfood.com/articles/89913-oxygenation-system-lowers-oxygen-demand-for-koch-foods-wastewater-treatment-facility?v=preview

FIGS. 2A-2C are various views of a schematic diagram of a dissolved air flotation (DAF) vessel. FIG. 2A is a top view, FIG. 2B is a side view of the long side of the DAF vessel, and FIG. 2C is a of the side view or end view of the short side of the DAF vessel.

FIG. 3A is a schematic diagram of a top view of an exemplary lateral diffuser.

FIG. 3B is a schematic diagram of a perspective view of an exemplary lateral diffuser.

FIG. 4 is a top perspective view of an exemplary lateral diffuser installed in a dissolved air flotation (DAF) vessel.

FIG. 5 is an exploded view of an exemplary aerator assembly.

FIG. 6 is a top view of an exemplary aerator (impeller).

FIG. 7 is a bottom view of an exemplary aerator (impeller).

### DETAILED DESCRIPTION

The wastewater treatment system and method disclosed herein provides an economical hybrid oxidation process for reducing dissolved Biological Oxygen Demand (BOD), Total Kjeldahl Nitrogen (TKN) contaminants and total suspended solids from wastewater discharge. The system employs a process of generating high purity oxygen which is incorporated into the wastewater (referred to herein as the Gener-Ox process). The high purity oxygen generation process uses a low amount of energy and takes place on-site. There is no requirement for storage of oxygen as the oxygen is generated in real time and utilized immediately after generation as a catalyst for biological reactions. In one embodiment, the Gener-Ox process may take place over an approximate detention time of one to four hours and achieve a 40%-80% reduction in BOD, a 25-50% reduction in TKN and 90% plus reduction in total suspended solids (TSS). Once the oxidation process is completed, the total suspended solids are removed by a flotation or clarification process described herein.

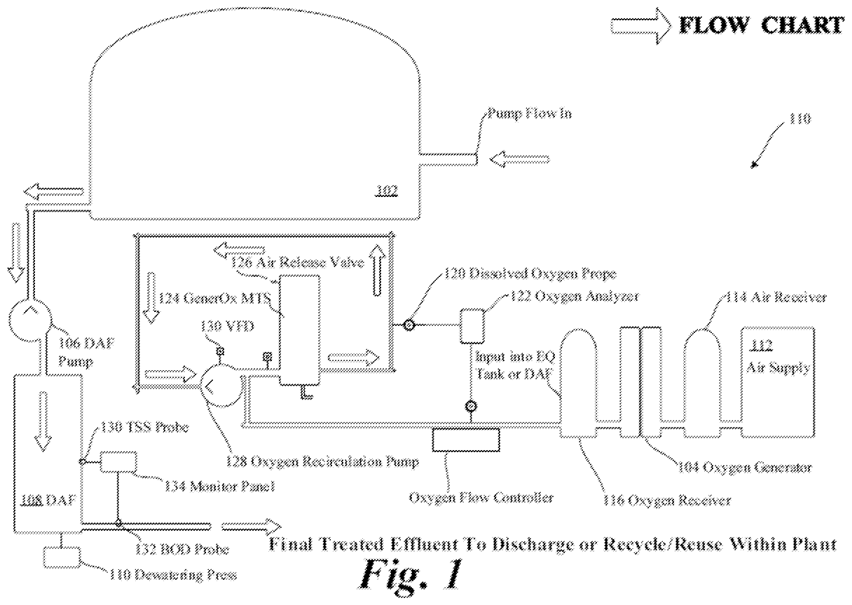

Provided herein is a process for dissolving oxygen in wastewater treatment systems for achieving Biological Oxygen Demand (BOD) and Total Kjeldahl Nitrogen (TKN) reduction. The wastewater treatment process described below is illustrated and referenced in FIG. 1 of the present disclosure. The wastewater treatment process begins by transporting wastewater containing a high concentration of nutrients (i.e., a highly nutrient concentrated wastewater) and contaminants to an equalization (EQ) tank (102). The EQ tank is capable of holding a sufficient volume of liquid to allow for a minimum of one to four hour detention time within the EQ tank. In general, longer hold times are beneficial for increasing nutrient reduction in the wastewater. The ideal pH of the wastewater in the EQ tank should be in the range of 6.0 to 7.0. The EQ tank is agitated by one or more mechanisms causing the wastewater stored in the EQ tank to be agitated. According to certain aspects of the present teaching, the EQ tank is agitated throughout the entire process, resulting in the continuous agitation of wastewater stored in the EQ tank.

Next, gas phase oxygen may be delivered from an on-site oxygen generation source (i.e., an oxygen generator (104)) to the EQ tank (102) to produce dissolved oxygen levels in the EQ tank. In certain cases, this step may constitute primary oxygenation of wastewater. According to certain aspects of the present teaching, the amount of dissolved oxygen produced in the wastewater in the EQ tank is 2 to 5 milligrams per liter or about 2 to about 5 milligrams per liter while the EQ tank is continuously agitated during the one to four hour detention period to enable the solution to remain fully aerobic throughout the entire period.

The oxidized wastewater solution is then removed from the EQ tank and transferred to a dissolved air flotation (DAF) vessel (108). This may be accomplished by the use of a dissolved air flotation (DAF) pump (106). The DAF vessel dissolves air under pressure into the wastewater at atmospheric pressure which causes the release of tiny air bubbles into the wastewater. The air bubbles provide a means to remove suspended materials from the surface of the treated wastewater by adhering to such materials and carrying the materials to be removed to the surface where they can be skimmed away. At this stage, additional gas phase oxygenation may be introduced into the wastewater through a series of specially perforated lateral hoses that are installed along the dissolved air flotation (DAF) vessel (108). The wastewater solution is continuously oxidized while the solution is transported through the dissolved air flotation (DAF) vessel to the point of discharge out of the (DAF) vessel. The nutrient oxidation in the wastewater produces and generates bio-solids in the process. These bio-solids are transported to the surface level of the dissolved air floatation (DAF) vessel and removed by scrapers on the surface. The bio-solids may then transported to a dewatering device (110) if necessary. However, the system provided herein often renders a dewatering device unnecessary as discussed in greater detail below. The dewatering device, if present, may be a belt filter press, screw press, centrifuge or screen device where the water fraction is removed and the nutrient bio-solids are dried. The dried nutrient solids are then disposed at a landfill or other destination of choice. The nutrient reduced wastewater is then transported to an authorized wastewater treatment facility or to a landfill for final disposal.

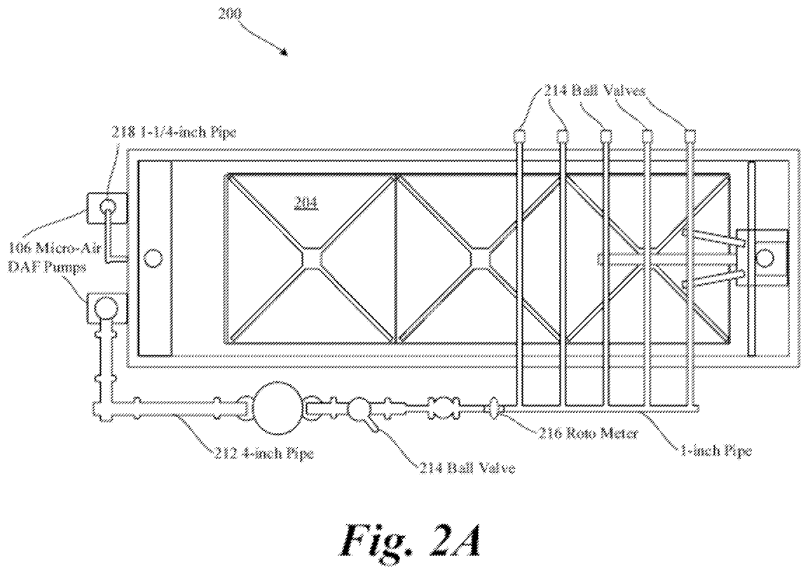

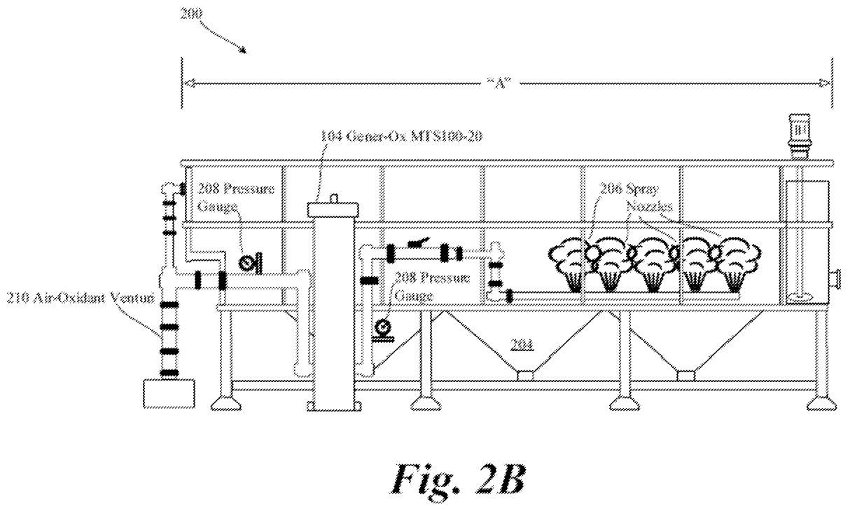

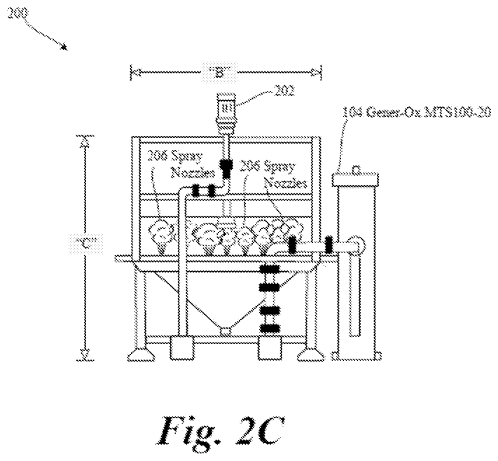

In summary, the equalizer (EQ) tank will have sufficient volume to allow detention of water volume for one to four hours with longer detention preferable. An on-site oxygen generation system produces sufficient dissolved oxygen to allow bio-oxidation of the nutrient contaminants within the one to four hours detention time allowed in the EQ tank. A Dissolved Air Floatation (DAF) system equipped with a series of perforated lateral diffusers allows for continued transfer of oxygen to the nutrient contaminated solution as the solution is transported through the DAF vessel. Scrapers remove solids which are accumulated on the surface and subsequently transfer the solids to a dewatering device for liquid fraction extraction. The dewatering system device, if present, may include a belt filter press, a screw press, a plate and frame type press or centrifuge, or a gravity screen for removal of the liquid fraction from the final residual process solids. DAF vessel 108 is further illustrated in FIGS. 2A-2C. FIGS. 2A-2C are various views of a schematic diagram of a dissolved air flotation (DAF) vessel. FIG. 2A is a top view, FIG. 2B is a side view of the long side of the DAF vessel, and FIG. 2C is a of the side view or end view of the short side of the DAF vessel. FIGS. 2A-2C will be described in further detail below.

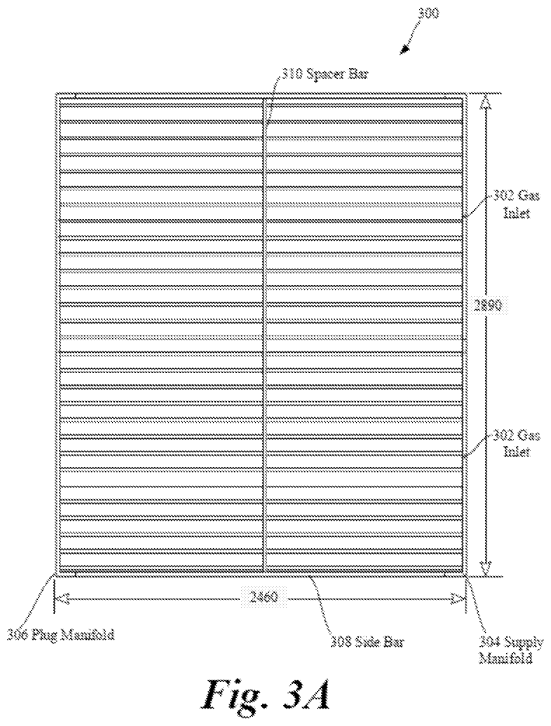

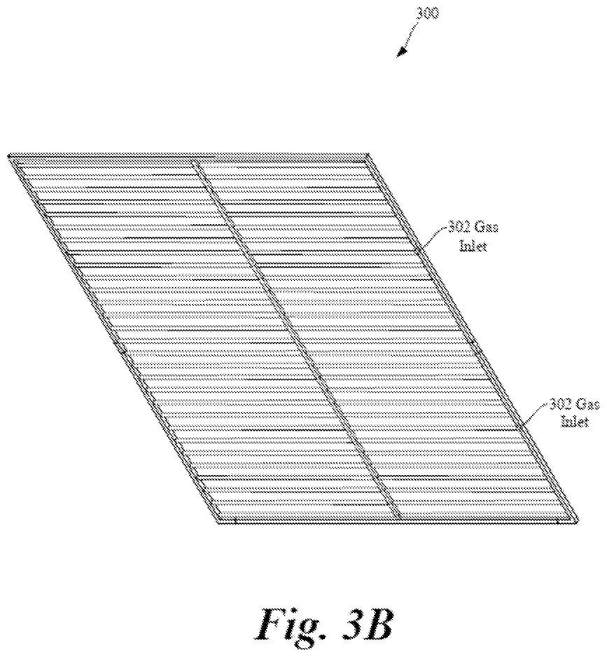

According to further aspects of the present teaching, lateral diffusers are utilized in either both or one of the equalization (EQ) tank and the dissolved air flotation (DAF) vessel to allow for the introduction of either air, gas phase oxygen or recycled wastewater into the treated wastewater. In certain embodiments, the lateral diffuser is a perforated hose that is incorporated into an aeration grid. The combination of the aeration grid and the lateral diffuser may be referred to as an aeration grid assembly. An exemplary embodiment of an aeration grid (300) is illustrated in FIGS. 3A and 3B. According to FIG. 3A, the aeration grid (300) includes an inlet (302) which introduces gas phase oxygen, air or recycled wastewater into the perforated lateral diffuser hose and ultimately into the treated wastewater. According to certain aspects of the present teaching, the aeration grid (300) forms a grid-like structure having a series of vertical and horizontal frame members and includes the following components, a supply manifold (304), a plug manifold (306), a side bar (308) and a spacer bar (310). According to one aspect of the present disclosure, the aeration grid includes a gas inlet (302) for the introduction of gas phase oxygen into the lateral diffuser hose and ultimately into the treated wastewater.

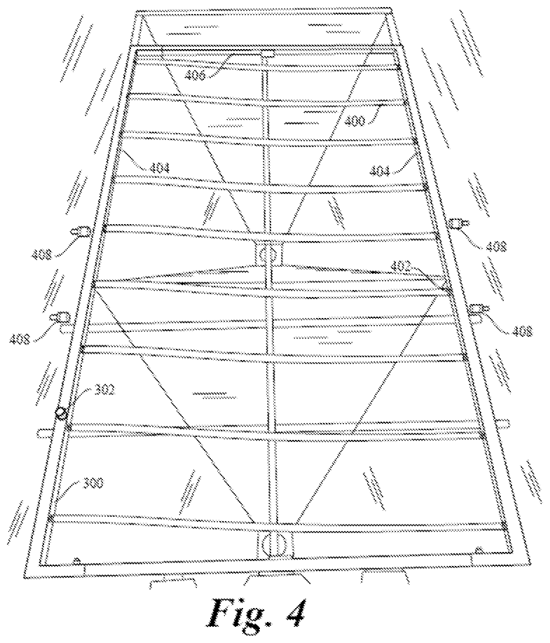

FIG. 4 illustrates an exemplary embodiment of an aeration grid assembly including an aeration grid (300) and perforated lateral diffuser hoses (400). The lateral diffuser hoses (400) are connected to the lateral ends or sides (e.g., a first side and a second side) of the aeration grid (300) by engaging the ends of the lateral diffuser hoses (400) to ports (402) built in two opposing longitudinal members (404) at the lateral ends or sides (e.g., a first side and a second side) of the aeration grid (300) and may be secured in place by clamps. Air, gas phase oxygen or wastewater enters the aeration grid (300) from an outlet (408) through a conduit (not shown) to an inlet (302) and passes through the interior of the longitudinal members (404) and lateral members (406) of the aeration grid (300) to the lateral diffuser hoses (400) and exits the lateral diffuser hoses (400) into the wastewater through perforations present in the lateral diffuser hoses (400). In the embodiment illustrated in FIG. 4, gas phase oxygen enters the aeration grid (300) through a gas inlet (302) and passes through the interior of the lateral members and medial members of the aeration grid (300) to the lateral diffuser hoses (400) and exits the lateral diffuser hoses (400) into the wastewater through perforations present in the lateral diffuser hoses (400).

According to certain aspects of the present teaching, the aeration grid assembly may be constructed from a 304 stainless steel alloy frame capable of housing numerous sections of lateral diffuser hose as illustrated in FIG. 4. The lateral diffuser hose is specially manufactured using a process which produces tens of thousands of small perforations in the house to allow for the release of gas phase air or oxygen introduced at the diffuser hose inlet. When compressed air is the gas utilized, the aeration grid assemblies (including the lateral diffuser hose) are mounted in a lower underwater flooded location in the dissolved air flotation (DAF) vessel and/or equalization (EQ) tank where the released air produces an upward flow of fine micro-bubble aeration. The micro-bubble aeration adheres to and removes suspended solids in the liquid by rising upward within the liquid and creating a dry float solids layer on the top surface of the liquid. The float solids layer fraction on the surface liquid may then be removed by a scraper mechanism and sent for further treatment or may be destined for disposal as a waste stream.

Alternatively, when gas phase oxygen is chosen, the aeration grid assemblies (including the lateral diffuser hose) are mounted in a lower underwater flooded location in the dissolved air flotation (DAF) vessel and/or equalization (EQ) tank where the released air produces an upward flow of fine micro-bubble aeration. The micro-bubble aeration of gas phase oxygen adheres to and removes suspended solids in the liquid by rising upward within the liquid. The gas phase oxygen functions to produce an oxygenated aerobic environment for biological conversion of soluble biological on demand (BOD) organic material to an insoluble total suspended solids (TSS). As the material rises in the liquid, total suspended solids accumulates and forms on the top surface of the liquid and creating a dry float solids layer. The float solids layer fraction on the surface liquid may then be removed by a scraper mechanism and sent for further treatment or may be destined for disposal as a waste stream.

By way of non-limiting example, the specially perforated lateral hoses in the dissolved air flotation (DAF) vessel are installed at approximately 24 to 36 inch spacing from each other horizontally along the bottom section of the dissolved air flotation (DAF) vessel. This setup maintains dissolved oxygen levels of 2 to 5 mg/L or about 2 to about 5 mg/L through to the point of dissolved air flotation (DAF) wastewater discharge all the while gas phase oxygen is continuously being added to oxidize the heavily contaminated nutrient wastewater solution. Thus, the wastewater solution is continuously being oxidized while the solution is being transported through the dissolved air flotation (DAF) vessel to the point of discharge out of the DAF vessel.

In summary, in the oxygenation process described above, lateral diffusers are installed internally within the equalization (EQ) tank and/or dissolved air flotation (DAF) vessel to allow for the introduction of gas phase oxygen (or alternatively compressed air or recycled wastewater) into the treated wastewater to achieve a desired saturation level of dissolved oxygen in the wastewater as it passes through the equalization (EQ) tank and/or dissolved air flotation (DAF) system. When used in an equalization (EQ) tank, the aeration grid assembly is of a larger scale size to accommodate the size of the equalization (EQ) tank.

As mentioned above, secondary oxygenation of wastewater occurs within the portion of the process that takes place in the dissolved air flotation (DAF) vessel. As shown in FIGS. 3 and 4, the DAF system (also referred to as the G-DAF system or vessel) employs the use of a perforated diffuser hose which is integrated in the structural frame of the aeration grid. The diffuser hose technology employed in the DAF system (referred to as the Gener-Ox linear diffuser hose) allows for oxygen gas flow to be up to 2 liters per minute (LPM) per 100 cm of diffuser hose at 80% standard oxygen transfer efficiency (SOTE). The diffuser hose may be made from rubber or any other material deemed suitable by a person of ordinary skill in the art. In certain aspects of the present teaching, the rubber may be a synthetic rubber or an elastomeric synthetic rubber. In further aspects of the present teaching, the Gener-Ox linear diffuser hose may be made from ethylene propylene diene monomer (EPDM or EPDM rubber) made of monomers that are mixed together in various proportions to form the EPDM material. The Gener-OX linear diffuser hose works with low pressure, optimally at approximately 3.5 psi. In certain applications the inner diameter of the Gener-Ox linear diffuser hose is 12.5 mm and the outer diameter s 19 mm. However, the size of the Gener-Ox linear diffuser hose may vary as deemed suitable by a person of ordinary skill in the art. The Gener-Ox linear diffuser hose mas a minimum of 60,000 laser made, micro perforations per 100 cm of length. The perforations are so small that it is nearly impossible to visually see them with the naked eye. The maximum length of the Gener-Ox linear diffuser hose is 200 cm. Each aeration grid assembly allows for approximately 34 meters of diffuser hose, thereby offering a maximum oxygen gas flow of up to 68 liters per minute (LPM). This allows for a massive volume of fine micro-aeration bubbles to enter the wastewater at the bottom of the DAF vessel. The micro-aeration bubbles are substantially transported or rise up from the bottom surface of the vessel through the volume wastewater to the surface of the wastewater in the G-DAF vessel or system. The micro-aeration bubbles adhere to materials in the wastewater carrying such materials to the surface of the wastewater. This serves to create a significant drying effect of the surface solids (float cake) in the G-DAF system as the oxygenated micro-aeration bubbles allow for increased detention time which provides additional reaction time for bacteria and microorganisms to decompose organic matter present in the wastewater. This results in a profound drying effect on the surface solids prior to transport/discharge. This feature often results in the elimination of the dewatering step which would otherwise be required. In certain embodiments, the dissolved air flotation vessel includes a total suspended solids (TSS) probe (130) and a biological oxygen demand (BOD) probe (132). These probes collect data on the amount of solids and organic material present in the treated wastewater and transmits the data to a monitor (134) which displays information received from the TSS and BOD probes as shown in FIG. 1.

Accordingly, according to one aspect of the present teaching, the dissolved air flotation system (G-DAF) disclosed herein is equipped with a series of perforated lateral diffuser hoses which allow for a continued transfer of dissolved oxygen to the remaining nutrient contaminant present in the wastewater solution received from the equalization tank. As the solution is transported through the G-DAF vessel, constant oxidation produces bio-solids, some of which migrate to the surface of the wastewater in the G-DAF system or vessel. Surface scrapers or rakes may then be used to remove the solids which have accumulated on the surface of the treated wastewater in the G-DAF system or vessel. The bio-solids may then be subsequently transferred (if necessary) to a dewatering device for extraction of the contained liquid fraction. The dewatering system device, if present, may consist of a belt filter press, screw press, plate and frame type press, centrifuge, rotating screen, vacuum drum filter or gravity screen for removal of the liquid fraction from the final residual process solids.

The aeration grid assembly described herein provides a number of benefits. First, it provides a highly efficient means for transferring air and oxygen into the wastewater for purposes of removing solids. It also provides an efficient initiation of the activated sludge process within the dissolved air flotation (DAF) vessel and process equipment. Second, the aeration grid assembly minimizes the equipment selection process as it is incorporated in the dissolved air flotation (DAF) vessel or system and eliminates the need for engineering additional tank requirements. Third, the perforated diffuser hose described herein provides extremely high standard of oxygen transfer efficiency rates (SOTE) to the bulk liquid water compared to other methods of oxygen transfer to bulk water. Fourth, the aeration grid assembly provides a super drying effect of the float solids layer and renders the collected solids more marketable for transport, reuse or resale.

According to certain aspects of the present teaching, the aeration grid assembly described above is positioned at the front portion of the dissolved air flotation (DAF) system above the dissolved air flotation (DAF) vessel. According to further aspects of the present teaching, an aerator (also referred to herein as a Gener-OX DAF Aerator or simply its component part, an impeller) is positioned upstream from the aeration grid assembly. According to certain aspects of the present teaching, the aerator includes an engineered oxygen gas intake impeller including five gas phase oxygen intake ports. However, other embodiments of the impeller are also contemplated. A schematic diagram of the aerator (202) positioned in the dissolved air flotation (DAF) system (200) is illustrated in FIGS. 2A-2C. FIGS. 2A-2C are various views of a schematic diagram of a dissolved air flotation (DAF) vessel. FIG. 2A is a top view, FIG. 2B is a side view of the long side of the DAF vessel, and FIG. 2C is a of the side view or end view of the short side of the DAF vessel.

Also, shown in dissolved air flotation (DAF) vessel of FIGS. 2A-2C are multiple dissolved air flotation (DAF) vessels (204), an oxygen generator (104), spray nozzles (206), pressure gauges (208), an air/oxidant venturi (210), a dissolved air flotation (DAF) micro-air pump (106), a pipe (212) for transporting wastewater into the DAF system including ball valves (214), a rotor meter (216), and a pipe (218) for transporting treated wastewater out of the DAF system. The spray nozzles may be utilized to spray either treated wastewater, compressed air or gas phase oxygen in the wastewater to be treated. In further embodiments described herein, the spray nozzles may be replaced by use of the perforated lateral diffuser hoses in the aeration grid assembly.

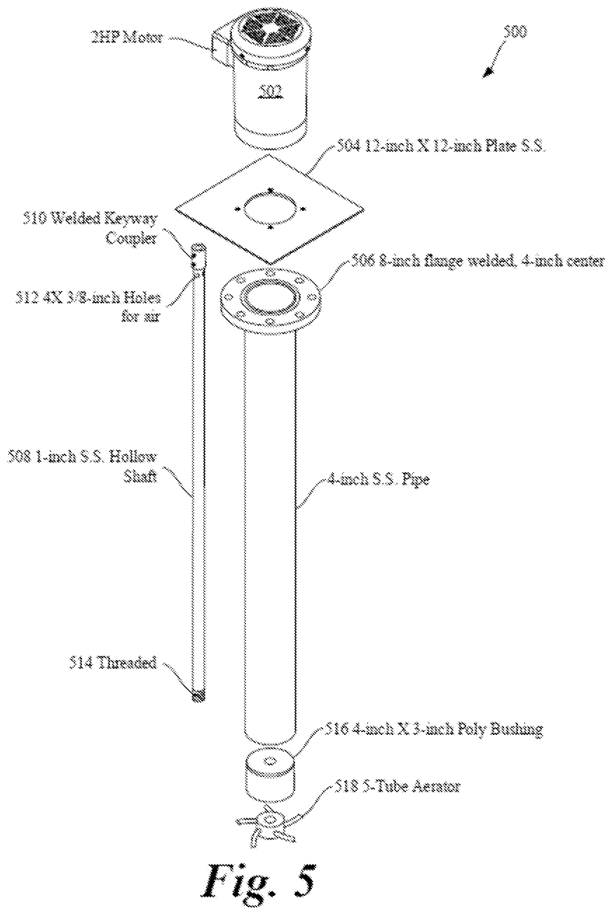

FIG. 5 illustrates a more detailed exploded view of the aerator shown in FIG. 2. The aerator assembly (500) of FIG. 5 includes a five tube aerator or impeller (512) which is driven in a rotational manner by a vertically oriented drive shaft (506) driven by an aerator pump (502). The vertically oriented drive shaft (506) may include a flange welded at its top end. According to certain embodiments, the flange has an eight inch diameter and a four inch center bore. According to certain embodiments, the vertically oriented drive shaft (506) is a stainless steel pipe having a four inch diameter. A plate (504) separates the aerator motor/pump (502) from the vertically oriented shaft (506) and a bushing may be positioned between the bottom end of the vertically oriented drive shaft (506) and the five tube aerator or impeller (512). According to certain embodiments, the plate (504) is a 12 by 12 inch stainless steel plate. The vertically oriented drive shaft (506) and driven shaft in the motor are connected together by a shaft coupling (508). According to certain embodiments, the shaft coupling (508) is a 1 inch stainless steel hollow shaft that includes a welded keyway coupler (510) at its top end, four holes (512) (e.g., ⅜ inch holes) at its top end for air, and a threaded bottom (514) to engage the five tube aerator or impeller (518). According to certain embodiments, a bushing (516) is positioned between the bottom end of the vertically oriented drive shaft (506) and the aerator or impeller (518). The bushing, in certain embodiments, may be a four by three inch polymeric bushing. It is to be understood that the specifications set forth above may differ depending on the particular application and may be modified by those of ordinary skill in the art for optimal performance.

According to certain aspects of the present teaching the aerator or impeller offers extremely low power consumption. In certain embodiments, only a two-horsepower motor is required. The motor may be driven by variable frequency drive (VFD) controller. In further embodiments, all component wear parts of the may be constructed of 316 stainless steel alloy with a polyurethane bushing holding the aeration shaft in place. The aerator or impeller may be constructed using a five-tube aeration hub design which produces maximum micro aeration volume. However, it is contemplated that the aerator or impeller may include any number of tubes and other hub designs in addition to those disclosed herein. According to further aspects of the present teaching, the aerator or impeller design includes no bearings or seals thereby eliminating maintenance such as greasing applications and/or replacement of seals and bearings.

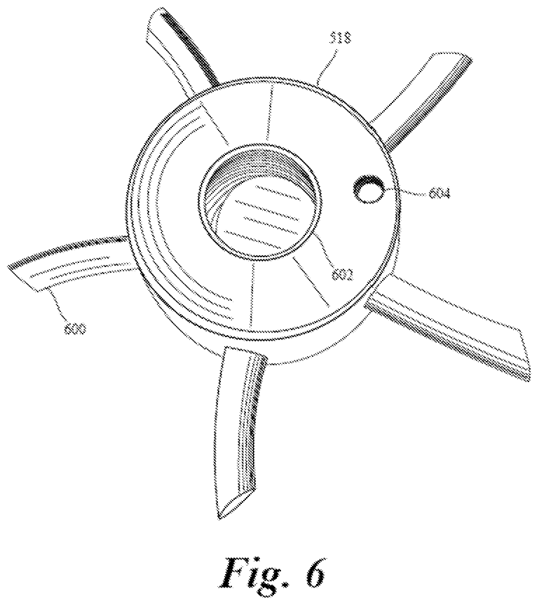

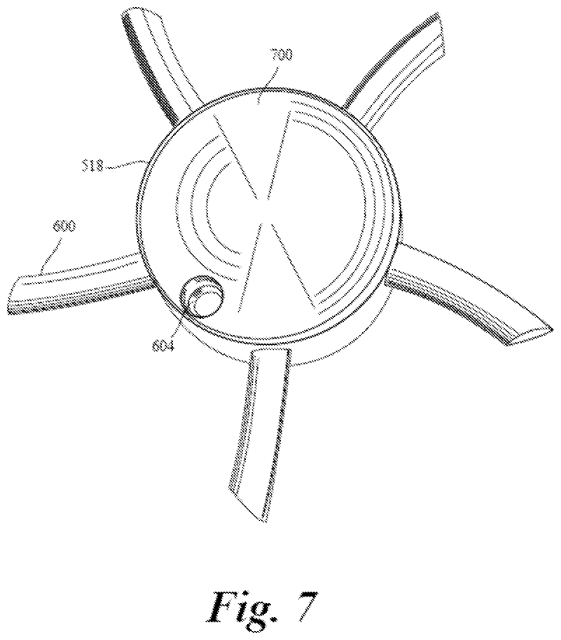

A more detailed illustration of the five tube aerator or impeller (518) is illustrated in FIGS. 6 and 7. FIG. 6 illustrates a top view of the five tube aerator or impeller (518) and

FIG. 7 illustrates a bottom view of the five tube aerator or impeller (518). The aerator or impeller (518) includes a center threaded bore (602) which receives a threaded bottom section of the vertically oriented drive shaft (506). The aerator or impeller (518) may also include a smaller bore offset from the center of the aerator or impeller (518) to allow for insertion of a set screw to secure the aerator or impeller (518) to the vertically oriented drive shaft. As shown in FIGS. 6 and 7, the aerator or impeller (518) includes five tubes (600). These tubes (600) during operation emit air (e.g., compressed air), gas phase oxygen or liquid during rotational operation of the aerator. The five tubes (600) may possess a slight curvature and may have an angular cut at its open end as illustrated in FIGS. 6 and 7. The rotational movement of the aerator or impeller (518) along with the size and shape of the five tubes (600) and the insertion of air or gas phased oxygen into the wastewater function to create a venturi effect in the wastewater resulting in a drop in pressure and increased fluid flow of liquid adjacent the aerator or impeller (518). This effect results in increased mobilization of micro-aeration bubbles into and towards the top surface of the wastewater.

The aerator or impeller provides a functional solution for improved float solids separation in the dissolved air flotation vessel or system and maintains fully aerobic conditions in the treated wastewater through to the point of discharge of wastewater from the dissolved air flotation vessel or system. It is to be understand that the dissolved air flotation system may include multiple or a plurality of dissolved air flotation vessels, aeration grid assemblies and aerators or impellers. The aerator or impeller disclosed herein is also capable of use for aeration of aerobic and highly odorous ponds, lagoons and wet wells. Therefore, the aerator or impeller may also be used for aeration and mixing in odorous storage tanks such as the equalization (EQ) tank.

According to further aspects of the present disclosure, the oxygen generation source which provides gas phase oxygen to the equalization (EQ), the dissolved air flotation (DAF) vessel and system including the diffuser hoses and the aerator or impeller is an on-site oxygen generation system (110) as shown in FIG. 1. The oxygenation system (110) includes an air supply (112) which harnesses air which is transported to an air receiver tank (114). The air receiver outputs the air to an oxygen generator (104) which produces gas phase oxygen and transports it to an oxygen receiver tank (116). Oxygen is then transported along various conduits to either the equalization (EQ) tank (102) or the dissolved air flotation (DAF) system or vessel (108). The oxygenation system includes at least one oxygen flow controller (118) positioned along one of the conduits to control the flow of gas phase oxygen to the equalization (EQ) tank (102) or the dissolved air flotation (DAF) system or vessel (108), a dissolved oxygen probe or sensor (120) to measure the content of dissolved oxygen in the gas as it passes through the various conduits, at least one oxygen analyzer (122) which analyzes and calculates the purity of the gas phase oxygen as it passes through the conduits, a saturator (124), an air release valve (126) on the saturator (124) which releases pressure from the system, and a recirculation pump (128) which is controlled by a variable frequency drive (VFD) controller (130) which transfers gas phase output from the equalization (EQ) tank or the dissolved air flotation (DAF) vessel for subsequent discharge from the saturator (124) or to the oxygen generation system (110) for processing or recharging into sufficiently pure gas phase oxygen for re-entry into the system.

The wastewater treatment system disclosed herein provides several advantages through the use of micro aeration. First, the lateral diffusers and/or aeration grid assemblies create instantaneous oxidation of any organic contaminants remaining in the wastewater after traditional treatment methods. Second, the massive volume of aeration microbubbles transported to wastewater surface in the G-DAF system or vessel creates a significant drying effect on the surface solids (float cake) present in the G-DAF system or vessel, thereby creating dry surface solids for discharge. Often this will result in the elimination of the dewatering step which is typically required.

In one experiment, the wastewater treatment system described herein treated 25 gallons per minute (GPM) with a flow rate of W/20,000 EQ and achieved the following results:

Total BOD (biological oxygen demand)=9300 mg/l

Soluble BOD=7300 mg/l,

TSS (total suspended solids)=7170,

FOG (fats, oils, grease)=1238 mg/l.

### Final Effluent

Total BOD=562 mg/l

Soluble BOD=552 mg/l,

TSS=44 mg/l,

FOG=17 mg/l.

Annual City Surcharge Savings=Approximately $36,000.00.

The following paragraphs describe various embodiments disclosed herein

A first embodiment of a wastewater treatment system includes an equalization tank which receives contaminated wastewater having contaminants and a high nutrient content from a plant; a dissolved air flotation system, wherein the dissolved air flotation system comprises at least one air dissolved air flotation vessel; at least one conduit which allows wastewater to be transferred from the equalization tank to the dissolved air flotation system; and, an on-site oxygen generation system for dissolving oxygen in the wastewater that is to be treated in the wastewater treatment system.

A subsequent embodiment of the wastewater treatment system, including any previous or subsequent embodiments of the wastewater treatment system includes the oxygen generation system dissolving gas phase oxygen into wastewater present in the equalization tank and/or the dissolved air flotation system.

A subsequent embodiment of the wastewater treatment system, including any previous or subsequent embodiments of the wastewater treatment system includes a lateral diffuser positioned in the equalization tank and/or the dissolved air flotation vessel.

A subsequent embodiment of the wastewater treatment system, including any previous or subsequent embodiments of the wastewater treatment system includes the lateral diffuser as a component of an aeration grid assembly which includes an aeration grid and the lateral diffuser, wherein the aeration grid includes lateral members and longitudinal members connected together and a port for receiving gas phase oxygen from the on-site oxygen generation system.

A subsequent embodiment of the wastewater treatment system, including any previous or subsequent embodiments of the wastewater treatment system includes the lateral diffuser having a perforated hose having a first end and a second end which extends along the lateral members of the aeration grid and which extends from a first longitudinal member to a second longitudinal member of the aeration grid, wherein the first end and the second end of the perforated hose engage a first port and a second port on the aeration grid.

A subsequent embodiment of the wastewater treatment system, including any previous or subsequent embodiments of the wastewater treatment system includes the aeration grid assembly being mounted in a bottom section comprising a lower underwater flooded location in the dissolved air flotation vessel and/or the equalization tank.

A subsequent embodiment of the wastewater treatment system, including any previous or subsequent embodiments of the wastewater treatment system wherein the perforated lateral diffuser hoses in the dissolved air flotation vessel are made from ethylene propylene diene monomer and have a minimum of 60,000 laser made micro-perforations per 100 cm of length.

A subsequent embodiment of the wastewater treatment system, including any previous or subsequent embodiments of the wastewater treatment system wherein the perforated lateral diffuser hoses in the dissolved air flotation vessel are installed at approximately 24 to 36 inch spacing from each other horizontally along the bottom section of the dissolved air flotation vessel and wherein the lateral diffusers in the aeration grid assembly continuously discharge gas phase oxygen into the contaminated wastewater to oxidize the wastewater.

A subsequent embodiment of the wastewater treatment system, including any previous or subsequent embodiments of the wastewater treatment system includes the aeration grid assembly maintains dissolved oxygen levels in wastewater present in the dissolved air flotation vessel of 2 to 5 mg/L or about 2 to about 5 mg/L through to the point of wastewater discharge from the dissolved air flotation vessel.

A subsequent embodiment of the wastewater treatment system, including any previous or subsequent embodiments of the wastewater treatment system includes the oxygen gas flow in the dissolved air flotation system being up to 2 liters per minute (LPM) per 100 cm of diffuser hose at 80% standard oxygen transfer efficiency.

A subsequent embodiment of the wastewater treatment system, including any previous or subsequent embodiments of the wastewater treatment system includes each aeration grid assembly positioned in a dissolved air flotation vessel in the dissolved air flotation system including approximately 34 meters of perforated lateral diffuser hose.

A subsequent embodiment of the wastewater treatment system, including any previous or subsequent embodiments of the wastewater treatment system wherein each aeration grid assembly positioned in a dissolved air flotation vessel in the dissolved air flotation system provides a maximum oxygen gas flow of up to 68 liters per minute (LPM).

A subsequent embodiment of the wastewater treatment system, including any previous or subsequent embodiments of the wastewater treatment system wherein the wastewater treatment system does not include a dewatering system.

A subsequent embodiment of the wastewater treatment system, including any previous or subsequent embodiments of the wastewater treatment system wherein an aerator is positioned upstream from the aeration grid assembly in the dissolved air flotation system.

A subsequent embodiment of the wastewater treatment system, including any previous or subsequent embodiments of the wastewater treatment system, wherein the aerator includes a tubed impeller.

A subsequent embodiment of the wastewater treatment system, including any previous or subsequent embodiments of the wastewater treatment system wherein the aerator includes a five tube impeller.

A subsequent embodiment of the wastewater treatment system, including any previous or subsequent embodiments of the wastewater treatment system, wherein the impeller is an oxygen gas intake impeller, wherein the five tubes on the impeller comprise oxygen intake ports, and wherein the tubes on the impeller have an open end which emits gas phase oxygen into the wastewater.

A subsequent embodiment of the wastewater treatment system, including any previous or subsequent embodiments of the wastewater treatment system, wherein the tubes on the impeller of the aerator have a curvature and an angular cut at its open end.

A subsequent embodiment of the wastewater treatment system, including any previous or subsequent embodiments of the wastewater treatment system, wherein rotational movement of the impeller of the aerator creates a venturi effect in the wastewater resulting in a pressure drop and increased fluid flow and increased mobilization of micro-aeration bubbles towards the surface of the wastewater.

A first embodiment of a method of treating wastewater in a wastewater treatment system includes transporting contaminated, nutrient rich wastewater to an equalization tank from a plant; delivering on-site gas phase oxygen form an oxygen generation system to the equalization tank and allowing the wastewater to remain in the equalization tank for a detention time of one to four hours at a pH in the range of 6.0 to 7.0; transporting treated wastewater from the equalization tank to a dissolved air flotation system, wherein the dissolved air flotation system comprises at least one dissolved air flotation vessel; providing an aeration grid assembly in the dissolved air flotation vessel of the dissolved air flotation system, wherein the aeration grid assembly comprises an aeration grid and a perforated lateral diffuser hose having a first end and a second end, wherein the aeration grid comprises lateral members and longitudinal members connected together and wherein the perforated lateral diffuser hose extends from a first longitudinal member to a second longitudinal member of the aeration grid, wherein the first end and the second end of the perforated hose engages a first port and a second port on the aeration grid; delivering on-site gas phase oxygen from an oxygen generation system to the aeration grid assembly in the dissolved air flotation vessel of the dissolved air flotation system, wherein the on-site gas phase oxygen enters the aeration grid through a port and enters the perforated lateral diffuser hose through the first port and/or the second port in the aeration grid and exits the perforated lateral diffuser hose into the wastewater through perforations present in the lateral diffuser hose; providing an aerator comprising a tubed impeller positioned upstream from the aeration grid assembly in the dissolved air flotation system, wherein the tubes on the impeller of the aerator have an open end, a curvature and an angular cut at the open end; delivering on-site gas phase oxygen from the oxygen generation system to the aerator, wherein the gas phase oxygen enters the aerator and exits the aerator through the open end of the tubes on the impeller into the wastewater thereby creating micro-aeration bubbles in the wastewater; rotating the impeller as the gas phase oxygen exits the tubes on the impeller to create a venturi effect on the micro-aeration bubbles which rise to the surface of the wastewater, thereby creating a dry float solids layer on the surface of the wastewater; and removing the dry float solids layer from the surface of the wastewater.

While the present disclosure has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the present disclosure without departing from the essential scope thereof. Therefore, it is intended that the present disclosure not be limited to the particular embodiments disclosed as the best mode contemplated for carrying out the invention, but that the present disclosure includes all embodiments falling within the scope of the appended claims. Further, the “invention” as that term is or may be used in this document is what is claimed in the claims of this document. The right to claim elements and/or sub-combinations that are disclosed herein as other inventions in other patent documents is hereby unconditionally reserved.

What is claimed is:

1. A wastewater treatment system comprising:
an equalization tank which receives contaminated wastewater having contaminants and a high nutrient content from a plant;
a dissolved air flotation system, wherein the dissolved air flotation system comprises at least one air dissolved air flotation vessel;
at least one conduit which allows wastewater to be transferred from the equalization tank to the dissolved air flotation system; and,
an on-site oxygen generation system for dissolving oxygen in the wastewater that is to be treated in the wastewater treatment system.

2. The wastewater treatment system of claim 1, wherein the oxygen generation system dissolves gas phase oxygen into wastewater present in the equalization tank and/or the dissolved air flotation system.

3. The wastewater treatment system of claim 2, comprising a lateral diffuser positioned in the equalization tank and/or the dissolved air flotation vessel.

4. The wastewater treatment system of claim 3, wherein the lateral diffuser is a component of an aeration grid assembly comprising an aeration grid and the lateral diffuser, wherein the aeration grid comprises lateral members and longitudinal members connected together and a port for receiving gas phase oxygen from the on-site oxygen generation system.

5. The wastewater treatment system of claim 4, wherein the lateral diffuser comprises a perforated hose having a first end and a second end which extends along the lateral members of the aeration grid and which extends from a first longitudinal member to a second longitudinal member of the aeration grid, wherein the first end and the second end of the perforated hose engage a first port and a second port on the aeration grid.

6. The wastewater treatment system of claim 5, wherein the aeration grid assembly is mounted in a bottom section comprising a lower underwater flooded location in the dissolved air flotation vessel and/or the equalization tank.

7. The wastewater treatment system of claim 6, wherein the perforated lateral diffuser hoses in the dissolved air flotation vessel are made from ethylene propylene diene monomer and have a minimum of 60,000 laser made micro-perforations per 100 cm of length.

8. The wastewater treatment system of claim 7, wherein the perforated lateral diffuser hoses in the dissolved air flotation vessel are installed at approximately 24 to 36 inch spacing from each other horizontally along the bottom section of the dissolved air flotation vessel and wherein the lateral diffusers in the aeration grid assembly continuously discharge gas phase oxygen into the contaminated wastewater to oxidize the wastewater.

9. The wastewater treatment system of claim 8, wherein the aeration grid assembly maintains dissolved oxygen levels in wastewater present in the dissolved air flotation vessel of 2 to 5 mg/L or about 2 to about 5 mg/L through to the point of wastewater discharge from the dissolved air flotation vessel.

10. The wastewater treatment system of claim 9, wherein the oxygen gas flow in the dissolved air flotation system is up to 2 liters per minute (LPM) per 100 cm of diffuser hose at 80% standard oxygen transfer efficiency.

11. The wastewater treatment system of claim 10, wherein each aeration grid assembly positioned in a dissolved air flotation vessel in the dissolved air flotation system comprises approximately 34 meters of perforated lateral diffuser hose.

12. The wastewater treatment system of claim 11, wherein each aeration grid assembly positioned in a dissolved air flotation vessel in the dissolved air flotation system provides a maximum oxygen gas flow of up to 68 liters per minute (LPM).

13. The wastewater treatment system of claim 12, wherein the wastewater treatment system does not include a dewatering system.

14. The wastewater treatment system of claim 13, wherein an aerator is positioned upstream from the aeration grid assembly in the dissolved air flotation system.

15. The wastewater treatment system of claim 14, wherein the aerator comprises a tubed impeller.

16. The wastewater treatment system of claim 14, wherein the aerator comprises a five tube impeller.

17. The wastewater treatment system of claim 16, wherein the impeller is an oxygen gas intake impeller, wherein the five tubes on the impeller comprise oxygen intake ports, and wherein the tubes on the impeller have an open end which emits gas phase oxygen into the wastewater.

18. The wastewater treatment system of claim 17, wherein the tubes on the impeller of the aerator have a curvature and an angular cut at its open end.

19. The wastewater treatment system of claim 18, wherein rotational movement of the impeller of the aerator creates a venturi effect in the wastewater resulting in a pressure drop and increased fluid flow and increased mobilization of micro-aeration bubbles towards the surface of the wastewater.

20. A method of treating wastewater in a wastewater treatment system comprising:
transporting contaminated, nutrient rich wastewater to an equalization tank from a plant;
delivering on-site gas phase oxygen form an oxygen generation system to the equalization tank and allowing the wastewater to remain in the equalization tank for a detention time of one to four hours at a pH in the range of 6.0 to 7.0;
transporting treated wastewater from the equalization tank to a dissolved air flotation system, wherein the dissolved air flotation system comprises at least one dissolved air flotation vessel;
providing an aeration grid assembly in the dissolved air flotation vessel of the dissolved air flotation system, wherein the aeration grid assembly comprises an aeration grid and a perforated lateral diffuser hose having a first end and a second end, wherein the aeration grid comprises lateral members and longitudinal members connected together and wherein the perforated lateral diffuser hose extends from a first longitudinal member to a second longitudinal member of the aeration grid, wherein the first end and the second end of the perforated hose engages a first port and a second port on the aeration grid;
delivering on-site gas phase oxygen from an oxygen generation system to the aeration grid assembly in the dissolved air flotation vessel of the dissolved air flotation system, wherein the on-site gas phase oxygen enters the aeration grid through a port and enters the perforated lateral diffuser hose through the first port and/or the second port in the aeration grid and exits the perforated lateral diffuser hose into the wastewater through perforations present in the lateral diffuser hose;
providing an aerator comprising a tubed impeller positioned upstream from the aeration grid assembly in the dissolved air flotation system, wherein the tubes on the impeller of the aerator have an open end, a curvature and an angular cut at the open end;
delivering on-site gas phase oxygen from the oxygen generation system to the aerator, wherein the gas phase oxygen enters the aerator and exits the aerator through the open end of the tubes on the impeller into the wastewater thereby creating micro-aeration bubbles in the wastewater;
rotating the impeller as the gas phase oxygen exits the tubes on the impeller to create a venturi effect on the micro-aeration bubbles which rise to the surface of the wastewater, thereby creating a dry float solids layer on the surface of the wastewater; and
removing the dry float solids layer from the surface of the wastewater.
